(19) United States
(12) Patent Application Publication
(10) Pub. No.: US 2020/0075224 A1
(43) Pub. Date: Mar. 5, 2020

(54) PLANAR TRANSFORMER

(71) Applicant: IBIDEN CO., LTD., Ogaki (JP)

(72) Inventors: Haruhiko MORITA, Ogaki (JP); Hitoshi MIWA, Ogaki (JP); Shinobu KATO, Ogaki (JP); Toshihiko YOKOMAKU, Ibi-gun (JP); Hisashi KATO, Ogaki (JP); Takahisa HIRASAWA, Ogaki (JP); Tetsuya MURAKI, Ogaki (JP); Takayuki FURUNO, Ogaki (JP)

(73) Assignee: IBIDEN CO., LTD., Ogaki (JP)

(21) Appl. No.: 16/555,194

(22) Filed: Aug. 29, 2019

(30) Foreign Application Priority Data
Sep. 3, 2018 (JP) 2018-164346

(51) Int. Cl. H01F 27/28; H01F 27/29; H01F 27/06

(52) U.S. Cl. CPC H01F 27/2804; H01F 27/29; H01F 2027/065; H01F 2027/2809; H01F 27/06

(57) ABSTRACT

A planar transfoinier includes a flexible insulating substrate having a pair of short sides, a pair of long sides, a first surface, and a second surface on an opposite side with respect to the first surface, multiple coils formed side by side on the first surface and second surface of the flexible insulating substrate such that each of the coils has a spiral-shaped wiring, and multiple terminals formed on the flexible insulating substrate and connected to the coils respectively such that the terminals are positioned in a center portion of the flexible insulating substrate formed close to a center of the long sides of the flexible insulating substrate. The flexible insulating substrate has multiple bending portions formed such that the flexible insulating substrate is folded at the bending portions and stacks the coils one another.

### CROSS-REFERENCE TO RELATED APPLICATIONS

The present application is based upon and claims the benefit of priority to Japanese Patent Application No. 2018-164346, filed Sep. 3, 2018, the entire contents of which are incorporated herein by reference.

### BACKGROUND OF THE INVENTION

### Field of the Invention

The present invention relates to a planar transformer formed by laminating primary coils and secondary coils.

### Description of Background Art

Japanese Patent Laid-Open Publication No. 2016-15453 describes a planar transformer formed by forming a primary winding and a secondary winding in respective layers of a multilayer wiring board. The entire contents of this publication are incorporated herein by reference.

### SUMMARY OF THE INVENTION

According to one aspect of the present invention, a planar transformer includes a flexible insulating substrate having a pair of short sides, a pair of long sides, a first surface, and a second surface on an opposite side with respect to the first surface, multiple coils formed side by side on the first surface and second surface of the flexible insulating substrate such that each of the coils has a spiral-shaped wiring, and multiple teiminals formed on the flexible insulating substrate and connected to the coils respectively such that the terminals are positioned in a center portion of the flexible insulating substrate formed close to a center of the long sides of the flexible insulating substrate. The flexible insulating substrate has multiple bending portions formed such that the flexible insulating substrate is folded at the bending portions and stacks the coils one another.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a developed plan view of a front surface side of a planar transformer according to a first embodiment of the present invention;

FIG. 2 is a developed plan view of a back surface side of the planar transformer of the first embodiment;

FIG. 3 is a plan view of an insulating substrate of the first embodiment;

FIG. 4A is a schematic cross-sectional view of the planar transformer of the first embodiment;

FIG. 4B is a cross-sectional view of the insulating substrate;

FIG. 4C is a cross-sectional view of a folded insulating substrate;

FIG. 5A is a side view of the planar transformer of the first embodiment;

FIG. 5B is a bottom view of the planar transformer;

FIG. 6 is a developed plan view of a front surface side of a planar transformer of a second embodiment;

FIG. 7 is a developed plan view of a back surface side of the planar transformer of the second embodiment;

FIG. 8A is a side view of the planar transformer of the second embodiment. FIG. 8B is a bottom view of the planar transformer;

FIG. 9 is a developed plan view of a front surface side of a planar transformer according to a modified embodiment of the second embodiment; and

FIG. 10 is a developed plan view of a back surface side of the planar transformer according to the modified embodiment of the second embodiment.

### DETAILED DESCRIPTION OF THE EMBODIMENTS

Embodiments will now be described with reference to the accompanying drawings, wherein like reference numerals designate corresponding or identical elements throughout the various drawings.

### First Embodiment

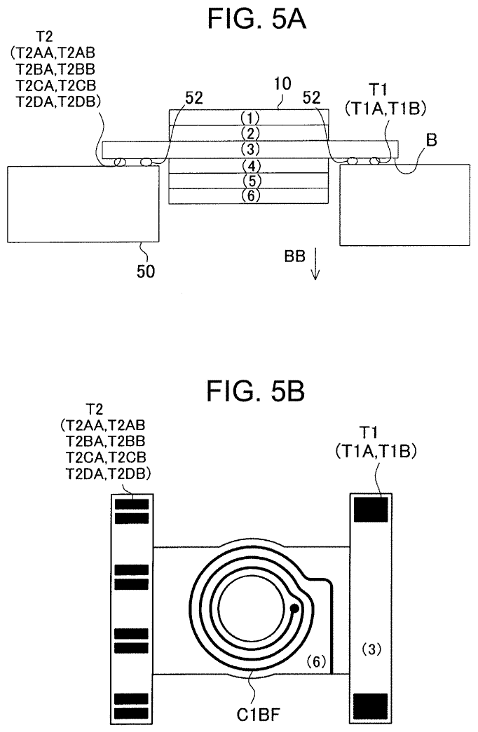

FIG. 5A is a side view of a planar transformer 10 of a first embodiment.

Input terminals (T1) and output terminals (T2) of the planar transformer 10 are connected to a power supply substrate 50 via solders 52.

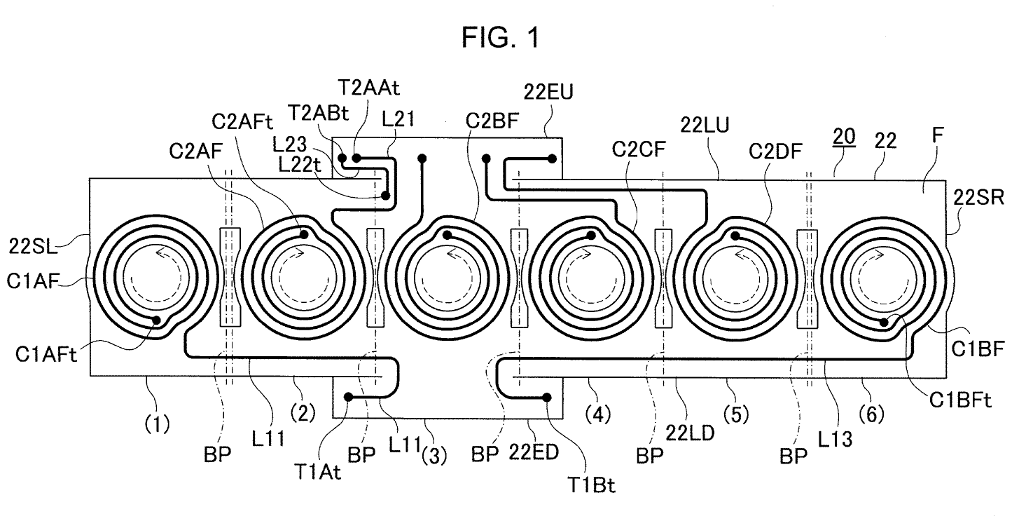

FIG. 1 is a developed plan view of a front surface side of the planar transfoinier 10 illustrated in FIG. 5A. An insulating substrate 22 includes six pieces (a first piece (1), a second piece (2), a third piece (3), a fourth piece (4), a fifth piece (5), and a sixth piece (6)). The planar transformer 10 illustrated in FIG. 5A is &limed by folding the first piece (1), the second piece (2), the third piece (3), the fourth piece (4), the fifth piece (5), and the sixth piece (6).

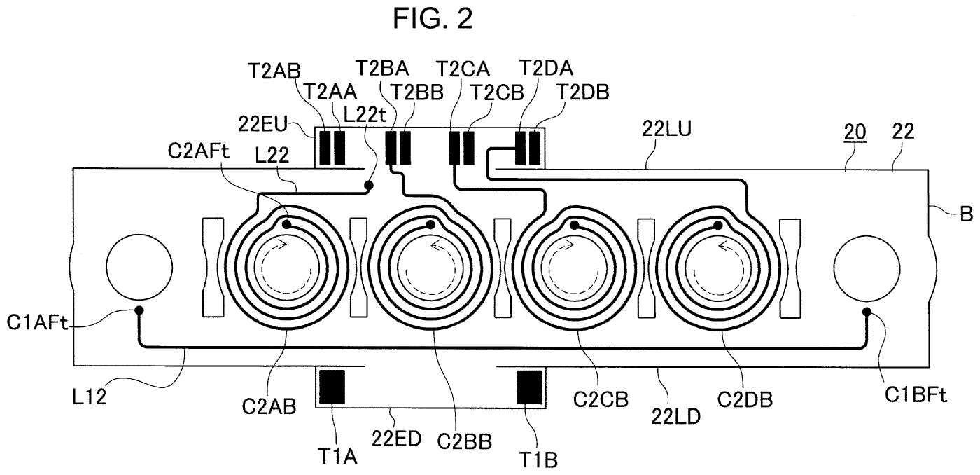

As illustrated in FIG. 1, a planar transformer substrate 20 has primary coils (C1AF, C1BF) and secondary coils (C2AF, C2BF, C2CF, C2DF) including spiral-shaped wirings formed by plating patterns on a first surface (front surface) (F) of the flexible polyimide insulating substrate 22. The insulating substrate 22 has a rectangular shape having a pair of short sides (22SR, 22SL) and a pair of long sides (22LU, 22LD). A pair of extending pieces (22EU, 22ED) each extending in a direction perpendicular to the long sides are formed in the third piece (3) near the center of the long sides (22LU, 22LD). The primary coils (C1AF, C1BF) and the secondary coils (C2AF, C2BF, C2CF, C2DF) are formed side by side along the pair of long sides (22LU, 22LD). As illustrated in FIGS. 1 and 2, the primary coils are formed only on the first surface (F) side of the insulating substrate 22. FIG. 2 is a developed plan view of a back surface side of the planar transformer 10 according to the first embodiment, but corresponds to a transparent view of coils, terminals and patterns formed on a second surface (B) side as seen from the first surface (F) side.

The insulating substrate 22 has, on the second surface (back surface) (B), a secondary coil (C2AB) on a back surface side of the secondary coil (C2AF), a secondary coil (C2BB) on a back surface side of the secondary coil (C2BF), a secondary coil (C2CB) on a back surface side of the secondary coil (C2CF), and a secondary coil (C2DB) on a back surface side of the secondary coil (C2DF). Output terminals (T2AA, T2AB, T2BA, T2BB, T2CA, T2CB, T2DA, T2DB) are provided on the extending piece (22EU). Input terminals (T1A, T1B) are provided on the extending piece (22ED).

The input terminal (T1A) provided on the second surface (B) side of the insulating substrate 22 is connected to the primary coil (C1AF) via a first input line (L11) provided on the first surface (F) side of a through hole (T1At). The primary coil (C1AF) is connected to a second input line (L12) provided on the second surface (B) side via a through hole (C1AFt). The second input line (L12) is connected to the primary coil (C1BF) via a through hole (C1BFt). The primary coil (C1BF) is connected to the input terminal (T1B) provided on the second surface (B) side via a third input line (L13) and a through hole (T1Bt).

An input current applied from the input terminal (T1A) flows to the primary coil (C1AF) via the through hole (T1At) and via the first input line (L11) provided on the first surface (F) side. The input current flows through the primary coil (C1AF) counterclockwise toward a center side, and then flows through the through hole (C1AFt) to the second input line (L12) provided on the second surface (B) side. The input current flows through the through hole (C1BFt) and then flows through the primary coil (C1BF) clockwise toward an outer peripheral side, and then flows through the third input line (L13) and the through hole (T1Bt) to the input terminal (T1B) provided on the second surface (B) side. Here, the primary coil (C1AF) and the primary coil (C1BF) oppose each other when the insulating substrate 22 is folded as will be described later, and thus the current flows in the same direction in both coils (in a clockwise direction in both coils when viewed from the first surface (F) side).

The output terminal (T2AA) provided on the second surface (B) side of the insulating substrate 22 is connected to a first output line (L21) provided on the first surface (F) side via a through hole (T2AAt). The first output line (L21) is connected to the secondary coil (C2AF). The secondary coil (C2AF) is connected to the secondary coil (C2AB) provided on the second surface (B) side via a through hole (C2AFt) provided on a center side of the secondary coil (C2AF). The secondary coil (C2AB) is connected to a second output line (L22). The second output line (L22) is connected to a third output line (L23) provided on the first surface (F) side via a through hole (L22t). The third output line (L23) is connected to a through hole (T2ABt). The through hole (T2ABt) is connected to the output terminal (T2AB) provided on the second surface (B) side.

An output current flows from the output terminal (T2AA) to the first output line (L21) provided on the first surface (F) side via the through hole (T2AAt). The output current flows through the first output line (L21), and then flows through the secondary coil (C2AF) clockwise toward a center side. The output current flows through the through hole (C2AFt) provided on a center side of the secondary coil (C2AF) and then flows through the secondary coil (C2AB) provided on the second surface (B) side clockwise toward an outer peripheral side. The output current flows from the secondary coil (C2AB) via the second output line (L22) to the through hole (L22t). The output current flows through the through hole (L22t) and then flows through the third output line (L23) provided on the first surface (F) side. The current flowing through the third output line (L23) flows through the through hole (T2ABt) to the output terminal (T2AB) provided on the second surface (B) side. As described above, FIG. 2 corresponds to a projection view when the secondary coil (C2AB) is viewed from the first surface side, and thus, the current direction of the secondary coil (C2AF) on the first surface (F) side and the current direction of the secondary coil (C2AB) on the second surface (B) side are both clockwise.

Similarly, the output terminal (T2BA) provided on the second surface (B) side of the insulating substrate 22 is connected to the secondary coil (C2BB). The secondary coil (C2BB) is connected to the secondary coil (C2BF), and the secondary coil (C2BF) is connected to the output terminal (T2BB). The output terminal (T2CA) is connected to the secondary coil (C2CB). The secondary coil (C2CB) is connected to the secondary coil (C2CF), and the secondary coil (C2CF) is connected to the output terminal (T2CB). The output terminal (T2DA) is connected to the secondary coil (C2DB). The secondary coil (C2DB) is connected to the secondary coil (C2DF), and the secondary coil (C2DF) is connected to the output terminal (T2DB).

The primary coil (C1AF) is formed on the first surface (F) of the first piece (1) illustrated in FIGS. 1 and 2. The secondary coil (C2AF) is formed on the first surface (F) of the second piece (2), and the secondary coil (C2AB) is formed on the second surface (B) of the second piece (2). A bending part (BP) is provided between the first piece (1) and the second piece (2). The secondary coil (C2BF) is formed on the first surface (F) of the third piece (3), and the secondary coil (C2BB) is formed on the second surface (B) of the third piece (3). A bending part (BP) is provided between the second piece (2) and the third piece (3). The secondary coil (C2CF) is formed on the first surface (F) of the fourth piece (4), and the secondary coil (C2CB) is formed on the second surface (B) of the fourth piece (4). A bending part (BP) is provided between the third piece (3) and the fourth piece (4). The secondary coil (C2DF) is fonned on the first surface (F) of the fifth piece (5), and the secondary coil (C2DB) is formed on the second surface (B) of the fifth piece (5). A bending part (BP) is provided between the fourth piece (4) and the fifth piece (5). The primary coil (C1BF) is formed on the first surface (F) of the sixth piece (6). A bending part (BP) is provided between the fifth piece (5) and the sixth piece (6).

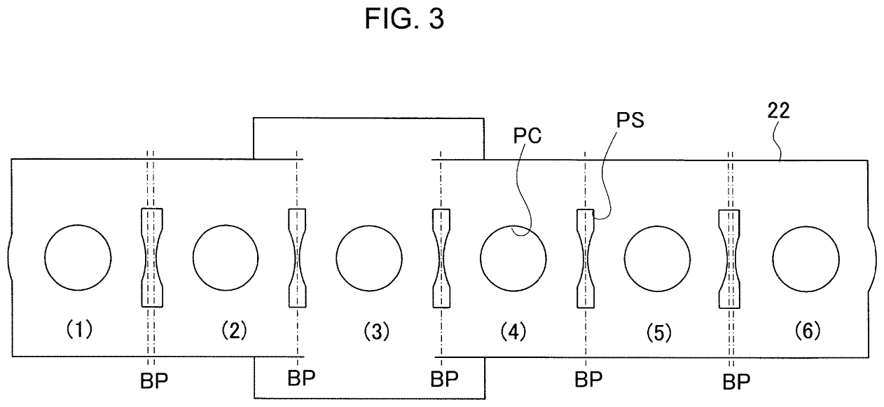

FIG. 3 is a plan view of the insulating substrate 22 excluding the coils and the like illustrated in FIG. 1.

A circular cut-out part (PC) is provided at a center part of a formation position of each of the coils. An iron core is inserted into the cut-out parts (PC) in the folded state. An hourglass-shaped cut-out part (PS) is provided in each of the bending parts (BP).

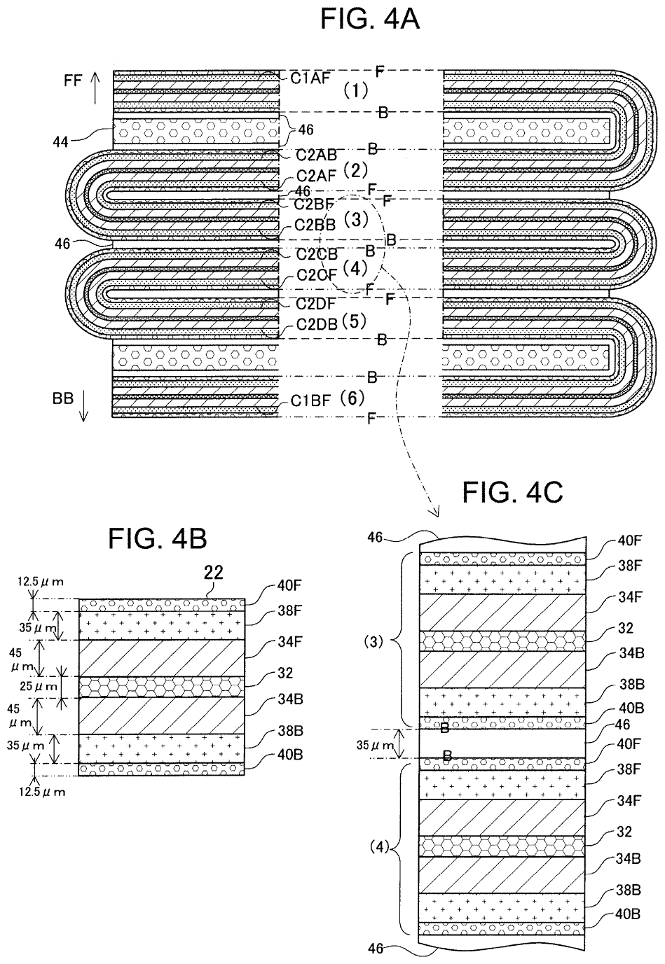

The first piece (1), the second piece (2), the third piece (3), the fourth piece (4), the fifth piece (5), and the sixth piece (6) of the insulating substrate 22 illustrated in FIGS. 1 and 2 are folded at the bending parts (BP), and the primary coils (C1AF, C1BF) and the secondary coils (C2AF, C2BF, C2CF, C2DF) are stacked on each other, and the planar transformer 10 is formed. That is, as illustrated in FIG. 4A, the second surface (B) of the first piece (1) and the second surface (B) of the second piece (2) are folded so as to oppose each other, the first surface (F) of the second piece (2) is folded so as to oppose the first surface (F) of the third piece (3), the second surface (B) of the third piece (3) is folded so as to oppose the second surface (B) of the fourth piece (4), the first surface (F) of the fourth piece (4) is folded so as to oppose the first surface (F) of the fifth piece (5), and the second surface (B) of the fifth piece (5) is folded so as to oppose the second surface (B) of the sixth piece (6).

FIG. 4A is a schematic cross-sectional view of the planar transformer 10. The primary coil (C1AF) provided on the first surface (F) of the first piece (1) faces an upper surface (FF). The second surface (B) of the first piece (1) on which a coil is not provided, opposes the secondary coil (C2AB) on the second surface (B) of the second piece (2). The secondary coil (C2AF) on the first surface (F) of the second piece (2) opposes the secondary coil (C2BF) on the first surface (F) of the third piece (3). The secondary coil (C2BB) on the second surface (B) of the third piece (3) opposes the secondary coil (C2CB) on the second surface (B) of the fourth piece (4). The secondary coil (C2CF) on the first surface (F) of the fourth piece (4) opposes the secondary coil (C2DF) on the first surface (F) of the fifth piece (5). The secondary coil (C2DB) on the second surface (B) of the fifth piece (5) opposes the second surface (B) of the sixth piece (6) on which a coil is not provided. The primary coil (C1BF) on the first surface (F) of the sixth piece (6) faces a lower surface (BB).

An insulating material 44 is inserted between the second surface (B) of the first piece (1) on which the primary coil (C1AF) is provided and the second piece (2) having the secondary coil (C2AB) provided on the second surface (B) thereof An adhesion layer 46 is provided between the second surface (B) of the first piece (1) and the insulating material 44, and an adhesion layer 46 is provided between the insulating material 44 and the second surface (B) of the second piece (2). As a result, insulation between the primary coil (C1AF) and the secondary coil (C2AB) is enhanced. Similarly, an insulating material 44 is inserted between the second surface (B) of the sixth piece (6) on which the primary coil (C1BF) is provided and the fifth piece (5) having the secondary coil (C2DB) provided on the second surface (B) thereof As a result, insulation between the primary coil (C1BF) and the secondary coil (C2DB) is enhanced.

FIG. 4B is a cross-sectional view of the insulating substrate 22.

Copper layers (34F, 34B) each having a thickness of 45 μm are respectively formed on two sides of a polyimide plate 32 having a thickness of 25 μm. The copper layers (34F, 34B) each include a copper foil having a thickness of 35 μm and a copper plating film having a thickness of 10 μm. Adhesion layers (38F, 38B) each having a thickness of 35 μm are respectively formed on the copper layers (34F, 34B), and cover films (40F, 40B) each having a thickness of 12.5 μm are respectively formed on the adhesion layers (38F, 38B).

FIG. 4C is a cross-sectional view of the folded insulating substrate 22. An adhesion layer 46 having a thickness of 35 μm is provided between the second surface (B) of the third piece (3) and the second surface (B) of the fourth piece (4), and the second surface (B) of the third piece (3) and the second surface (B) of the fourth piece (4) are adhered to each other via the adhesion layer 46.

The primary coils (C1AF, C1BF) are each formed in 10 turns. Secondary coils (C2AF, C2BF, C2CF, C2DF, C2AB, C2BB, C2CB, C2DB) are each formed in 12 turns.

In the planar transformer 10 of the first embodiment, with respect to an input voltage applied to the input terminals (T1A, T1B), a voltage of 1.2 times is output by the output terminals (T2AA-T2AB), a voltage of 3.6 times is output by the output terminals (T2AA-T2CB), and a voltage of 4.8 times is output by the output terminals (T2AA-T2DB).

FIG. 5A is a side view of the planar transformer 10 of the first embodiment, and FIG. 5B is a bottom view of the planar transformer 10.

The planar transformer 10 of the first embodiment is formed such that the second surface (B) side of the third piece (3) faces the lower surface (BB). Therefore, the input terminals (T1) (T1A, T1B) and the output terminals (T2) (T2AA, T2AB, T2BA, T2BB, T2CA, T2CB, T2DA, T2DB) provided on the second surface (B) side of the third piece (3) face the lower surface (BB). Therefore, the input terminals (T1) and the output terminals (T2) can be easily connected to the power supply substrate 50 via the solders 52.

According to the first embodiment, in the planar transformer 10, by folding the flexible insulating substrate 22 having the primary coils (C1AF, C1BF) and the secondary coils (C2AF, C2BF, C2CF, C2DF, C2AB, C2BB, C2CB, C2DB) formed side by side on the first surface (F) and the second surface (B), the primary coils and the secondary coils are stacked on each other. That is, the planar transformer is formed by forming the coils on the first surface (F) and the second surface (B) of the one insulating substrate 22 and folding the insulating substrate 22. Therefore, as compared to the case where coils are fonned by build-up lamination, manufacturing time can be shortened and manufacturing cost can be reduced.

In the planar transformer 10 of the first embodiment, the secondary coils (C2AF, C2BF, C2CF, C2DF, C2AB, C2BB, C2CB, C2DB) are formed on the insulating substrate 22 between the pair of primary coils (C1AF, C1BF). Then, by folding the insulating substrate 22, the stacked secondary coils (C2AF, C2BF, C2CF, C2DF, C2AB, C2BB, C2CB, C2DB) are sandwiched between the primary coils (C1AF, C1BF). As a result, magnetic flux leakage is reduced, and efficiency of the planar transfoinier 10 is increased.

In the planar transformer 10 of the first embodiment, the secondary coils (C2AF, C2BF, C2CF, C2DF) are provided on the first surface (F) of the insulating substrate 22, and the secondary coils (C2AB, C2BB, C2CB, C2DB) are provided on the second surface (B) of the insulating substrate 22. The primary coils (C1AF, C1BF) are provided on the first surface (F) of the insulating substrate 22. By folding the insulating substrate 22, the second surface (B) on an opposite side with respect to the side where the primary coil (C1AF) is provided opposes the outermost secondary coil (C2AB), and the second surface (B) on an opposite side with respect to the side where the primary coil (C1BF) is provided opposes the outermost secondary coil (C2DB). An insulation distance between the primary coil (C1AF) and the secondary coil (C2AB) and an insulation distance between the primary coil (C1BF) and the secondary coil (C2DB) are secured, and insulation reliability is increased.

In the planar transformer 10 of the first embodiment, the input lines (L11, L12, L13) connecting to the primary coils and to the input terminals are provided along the long side (22LD) on one side of the insulating substrate 22, and the output lines (L21,L22, L23) connecting to the secondary coils and to the output terminals are provided along the long side (22LU) on the other side of the insulating substrate 22. Distances between the input lines and the output lines are increased, and insulation reliability is increased.

In the planar transformer 10 of the first embodiment, the pair of extending pieces (22EU, 22ED) each extending in a direction perpendicular to the long sides are formed in the third piece (3) near the center of the long sides (22LU, 22LD), the output terminals (T2) (T2AA, T2AB, T2BA, T2BB, T2CA, T2CB, T2DA, T2DB) are provided in the extending piece (22EU), and the input terminals (T1) (T1A, T1B) are provided in the extending piece (22ED). The input terminals (T1) connected to the primary coils and the output terminals (T2) connected to the secondary coils are provided near the center of the long sides of the insulating substrate 22. Distances between the primary coils and the input terminals and between the secondary coils and the output terminals are shortened, and resistive loss due to input lines and output lines is reduced.

### Second Embodiment

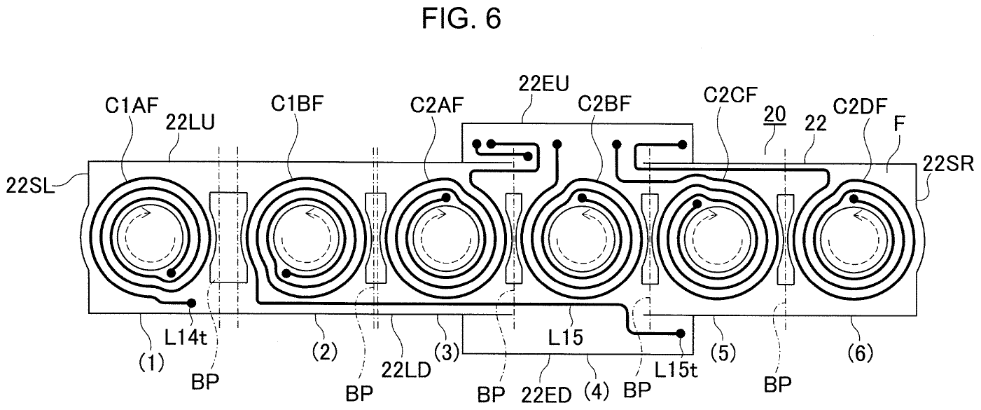

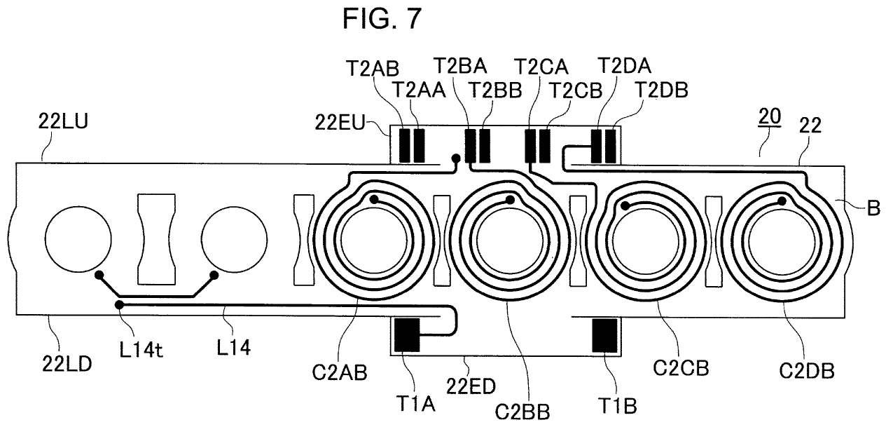

FIG. 6 is a developed plan view of a front surface side of a planar transformer 10 according to a second embodiment. FIG. 7 is a developed plan view of a back surface side of the planar transfomier 10, but corresponds to a transparent view of coils, terminals and patterns formed on a second surface (B) side as seen from a first surface (F) side.

A planar transformer substrate 20 has primary coils (C1AF, C1BF) on one short side (22SL) side on a first surface (front surface) (F) of a flexible polyimide insulating substrate 22. The planar transformer substrate 20 has secondary coils (C2AF, C2BF, C2CF, C2DF) on the other short side (22SR) side. The planar transformer substrate 20 has, on a second surface (back surface) (B) of the insulating substrate 22, a secondary coil (C2AB) on a back surface side of the secondary coil (C2AF), a secondary coil (C2BB) on a back surface side of the secondary coil (C2BF), a secondary coil (C2CB) on a back surface side of the secondary coil (C2CF), and a secondary coil (C2DB) on a back surface side of the secondary coil (C2DF). The primary coils (C1AF, C1BF) are formed only on the first surface (F) of the insulating substrate 22.

In the planar transformer 10 of the second embodiment, a pair of extending pieces (22EU, 22ED) each extending in a direction perpendicular to the long sides are formed in the fourth piece (4) near the center of the long sides (22LU, 22LD). Output terminals (T2AA, T2AB, T2BA, T2BB, T2CA, T2CB, T2DA, T2DB) and input terminals (T1A, T1B) are provided on the extending pieces (22EU, 22ED).

In the planar transformer 10 of the second embodiment, the extending pieces (22EU, 22ED) are formed in the fourth piece (4) near the center of the long sides (22LU, 22LD), the output terminals (T2) (T2AA, T2AB, T2BA, T2BB, T2CA, T2CB, T2DA, T2DB) are provided in the extending piece (22EU), and the input terminals (T1) (T1A, T1B) are provided in the extending piece (22ED). The input terminal (T1A) and the primary coil (C1AF) are connected to each other via a fourth input line (L14) and a through hole (L14t). The primary coil (C1BF) and the input terminal (T1B) are connected to each other via a fifth input line (L15) and a through hole (L15t). The input terminals (T1) connected to the primary coils and the output terminals (T2) connected to the secondary coils are provided near the center of the long sides of the insulating substrate 22. Distances between the primary coils and the input terminals and between the secondary coils and the output terminals are shortened, and resistive loss due to input lines and output lines is reduced.

In the planar transformer 10 of the second embodiment, the primary coil (C1AF) and the primary coil (C1BF) are formed adjacent to each other on the one short side (22SL) side. Therefore, as compared to the case where the primary coil (C1AF) and the primary coil (C1BF) are respectively formed on the two short sides (22SL, 22SR) of the substrate, a distance between the primary coil (C1AF) and the primary coil (C1BF) is shortened, an input line connecting the two primary coils can be shortened, and resistive loss due to the input line is reduced.

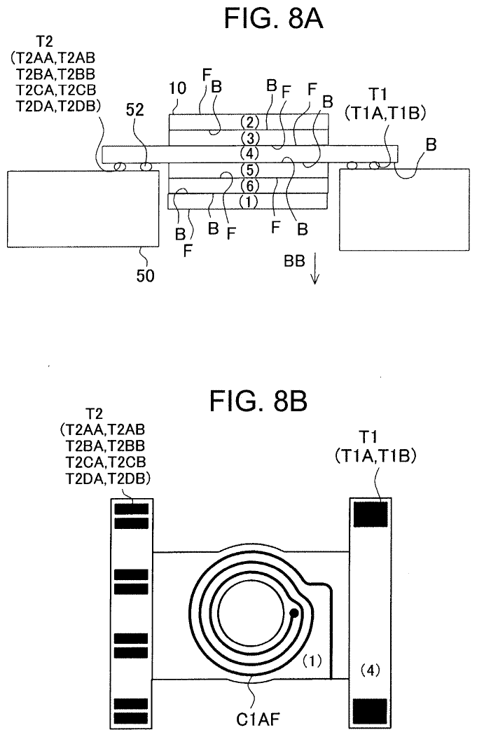

FIG. 8A is a side view of the planar transformer 10 of the second embodiment, and FIG. 8B is a bottom view of the planar transformer 10.

The insulating substrate 22 illustrated in FIGS. 6 and 7 is folded such that the third piece (3), the fourth piece (4), the fifth piece (5), and the sixth piece (6), on which the secondary coils are formed, are all stacked on each other, and are sandwiched between the first piece (1) and the second piece (2), on which the primary coils are formed. That is, as illustrated in FIG. 8A, the first surface (F) of the third piece (3) is folded so as to oppose the first surface (F) of the fourth piece (4), the second surface (B) of the fourth piece (4) is folded so as to oppose the second surface (B) of the fifth piece (5), and the first surface (F) of the fifth piece (5) is folded so as to oppose the first surface (F) of the sixth piece (6). Then, the first piece (1) is folded such that the second surface (B) of the first piece (1) opposes the second surface (B) of the second piece (2), and the third piece (3), the fourth piece (4), the fifth piece (5), and sixth piece (6) are sandwiched between the first piece (1) and the second piece (2).

### Modified Embodiment of Second Embodiment

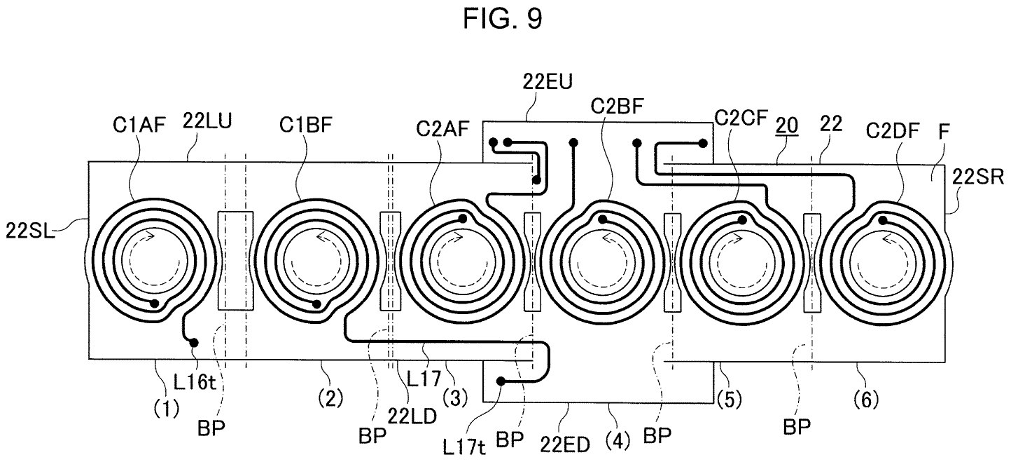

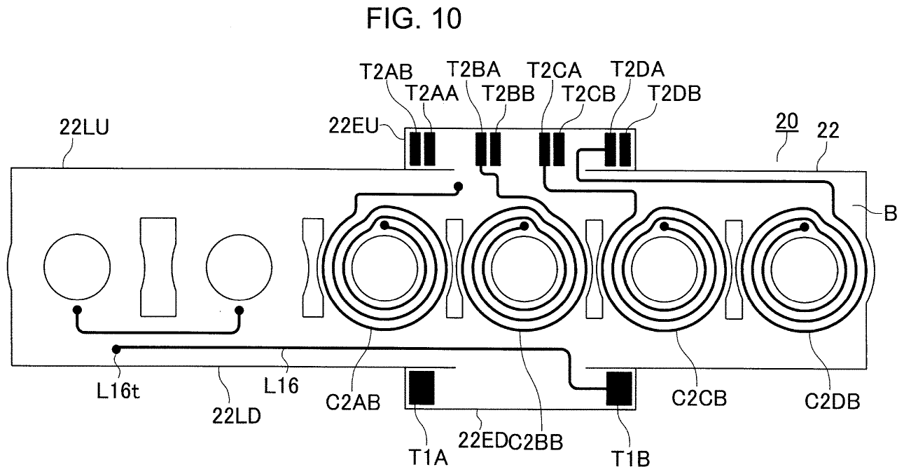

FIG. 9 is a developed plan view of a front surface side of a planar transformer 10 according to a modified embodiment of the second embodiment. FIG. 10 is a developed plan view of a back surface side of the planar transformer 10, but corresponds to a transparent view of coils, terminals and patterns formed on a second surface (B) side as seen from a first surface (F) side.

A planar transformer substrate 20 has primary coils (C1AF, C1BF) on one short side (22SL) side on a first surface (front surface) (F) of an insulating substrate 22. The planar transformer substrate 20 has secondary coils (C2AF, C2BF, C2CF, C2DF) on the other short side (22SR) side. The planar transformer substrate 20 has, on a second surface (back surface) (B) of the insulating substrate 22, a secondary coil (C2AB) on a back surface side of the secondary coil (C2AF), a secondary coil (C2BB) on a back surface side of the secondary coil (C2BF), a secondary coil (C2CB) on a back surface side of the secondary coil (C2CF), and a secondary coil (C2DB) on a back surface side of the secondary coil (C2DF). The primary coils (C1AF, C1BF) are formed only on the first surface (F) of the insulating substrate 22.

In the planar transformer 10 of the modified embodiment of the second embodiment, a pair of extending pieces (22EU, 22ED) each extending in a direction perpendicular to long sides are formed in the fourth piece (4) near the center of the long sides (22LU, 22LD), output ten finals (T2) (T2AA, T2AB, T2BA, T2BB, T2CA, T2CB, T2DA, T2DB) are provided in the extending piece (22EU), and input terminals (T1) (T1A, T1B) are provided in the extending piece (22ED). The input terminal (T1B) and the primary coil (C1AF) are connected to each other via a sixth input line (L16) and a through hole (L16t). The primary coil (C1BF) and the input terminal (T1A) are connected to each other via a seventh input line (L17) and a through hole (L17t). The input terminals (T1) connected to the primary coils and the output terminals (T2) connected to the secondary coils are provided near the center of the long sides of the insulating substrate 22. Distances between the primary coils and the input terminals and between the secondary coils and the output terminals are shortened, and resistive loss due to input lines and output lines is reduced.

In the planar transformer 10 of the modified embodiment of the second embodiment, the primary coil (C1AF) and the primary coil (C1BF) are formed adjacent to each other on the one short side (22SL) side. Therefore, a distance between the primary coil (C1AF) and the primary coil (C1BF) is shortened, an input line connecting the two primary coils can be shortened, and resistive loss due to the input line is reduced.

In Japanese Patent Laid-Open Publication No. 2016-15453, since the windings in the respective layers of the multilayer wiring board are provided by build-up lamination, it is thought that manufacturing time is long and cost is high.

A planar transformer according to an embodiment of the present invention includes: a rectangular-shaped flexible insulating substrate having a first surface and a second surface on an opposite side with respect to the first surface and having a pair of short sides and a pair of long sides; and primary coils and secondary coils that include spiral-shaped wirings provided on the first surface and the second surface of the flexible insulating substrate and are formed side by side. By folding the flexible insulating substrate, the primary coils and the secondary coils are stacked on each other. Input terminals connected to the primary coils and output terminals connected to the secondary coils are provided near a center of the long sides of the flexible insulating substrate.

According to an embodiment of the present invention, in the planar transformer, by folding the flexible insulating substrate having the primary coils and the secondary coils formed side by side on the first surface and the second surface, the primary coils and the secondary coils are stacked on each other. That is, the planar transformer is formed by forming the coils on the first surface (front surface) and the second surface (back surface) of the one flexible insulating substrate and folding the flexible insulating substrate. Therefore, as compared to the case where coils are formed by build-up lamination, manufacturing time can be shortened and manufacturing cost can be reduced. The input terminals connected to the primary coils and the output terminals connected to the secondary coils are provided near the center of the long sides of the flexible insulating substrate. Distances between the primary coils and the input terminals and between the secondary coils and the output terminals are shortened, and resistive loss due to input lines and output lines is reduced.

Obviously, numerous modifications and variations of the present invention are possible in light of the above teachings. It is therefore to be understood that within the scope of the appended claims, the invention may be practiced otherwise than as specifically described herein.

1. A planar transformer, comprising:
a flexible insulating substrate having a pair of short sides, a pair of long sides, a first surface, and a second surface on an opposite side with respect to the first surface;
a plurality of coils fanned side by side on the first surface and second surface of the flexible insulating substrate such that each of the coils has a spiral-shaped wiring; and
a plurality of tei inals formed on the flexible insulating substrate and connected to the plurality of coils respectively such that the plurality of terminals is positioned in a center portion of the flexible insulating substrate formed close to a center of the long sides of the flexible insulating substrate,
wherein the flexible insulating substrate has a plurality of bending portions formed such that the flexible insulating substrate is configured to be folded at the bending portions and stack the plurality of coils one another.

2. The planar transformer according to claim 1, wherein the plurality of coils includes a plurality of primary coils and a plurality of secondary coils, and the plurality of terminals includes a plurality of input terminals and a plurality of output coils such that the input terminals are connected to the primary coils respectively and that the output coils are connected to the secondary coils respectively.

3. The planar transformer according to claim 2, wherein the plurality of primary coils includes a pair of primary coils such that the plurality of secondary coils is formed between the pair of primary coils and that the flexible insulating substrate is configured to be folded at the bending portions and stack the secondary coils between the pair of the primary coils.

4. The planar transformer according to claim 3, wherein the flexible insulating substrate is configured to be folded at the bending portions such that each of the primary coils faces an outermost secondary coil formed on one of the first surface and the second surface which is on an opposite side with respect to the other one of the first surface and the second surface on which the primary coils are formed.

5. The planar transformer according to claim 4, wherein the plurality of terminals is formed on one of the first surface and the second surface of the flexible insulating substrate such that the plurality of primary coils is formed on the other one of the first surface and the second surface of the flexible insulating substrate.

6. The planar transformer according to claim 2, further comprising:
a plurality of input lines formed on one of the first surface and the second surface of the flexible insulating substrate such that the plurality of input lines is connected to the primary coils and that the plurality of input lines is formed along one of the pair of long sides; and
a plurality of output lines formed on the one of the first surface and the second surface of the flexible insulating substrate such that the plurality of output lines is connected to the secondary coils and that the plurality of output lines is foimed along the other one of the pair of long sides.

7. The planar transformer according to claim 2, wherein the plurality of primary coils includes a pair of primary coils formed adjacent to one of the short sides of the flexible insulating substrate, the plurality of secondary coils is formed adjacent to each other on the other one of short sides of the flexible insulating substrate, and the flexible insulating substrate is configured to be folded at the bending portions such that the plurality of secondary coils is stacked one another between the pair of primary coils.

8. The planar transformer according to claim 2, wherein the plurality of input terminals and the plurality of output terminals are positioned to mount a power supply substrate to the second surface of the flexible insulating substrate.

9. The planar transformer according to claim 1, wherein the flexible insulating substrate has a rectangular-shaped portion having the pair of long sides and the pair of short sides, and a plurality of extending piece portions such that the plurality of ter finals are formed on the plurality of extending piece portions.

10. The planar transformer according to claim 9, wherein the plurality of coils includes a plurality of primary coils and a plurality of secondary coils, and the plurality of terminals includes a plurality of input terminals and a plurality of output coils such that the input terminals are connected to the primary coils respectively and that the output coils are connected to the secondary coils respectively.

11. The planar transformer according to claim 10, wherein the plurality of primary coils includes a pair of primary coils such that the plurality of secondary coils is formed between the pair of primary coils and that the flexible insulating substrate is configured to be folded at the bending portions and stack the secondary coils between the pair of the primary coils.

12. The planar transformer according to claim 11, wherein the flexible insulating substrate is configured to be folded at the bending portions such that each of the primary coils faces an outermost secondary coil formed on one of the first surface and the second surface which is on an opposite side with respect to the other one of the first surface and the second surface on which the primary coils are formed.

13. The planar transformer according to claim 12, wherein the plurality of terminals is formed on one of the first surface and the second surface of the flexible insulating substrate such that the plurality of primary coils is formed on the other one of the first surface and the second surface of the flexible insulating substrate.

14. The planar transformer according to claim 10, further comprising:
a plurality of input lines formed on one of the first surface and the second surface of the flexible insulating substrate such that the plurality of input lines is connected to the primary coils and that the plurality of input lines is formed along one of the pair of long sides; and
a plurality of output lines formed on the one of the first surface and the second surface of the flexible insulating substrate such that the plurality of output lines is connected to the secondary coils and that the plurality of output lines is formed along the other one of the pair of long sides.

15. The planar transfonner according to claim 10, wherein the plurality of primary coils includes a pair of primary coils formed adjacent to one of the short sides of the flexible insulating substrate, the plurality of secondary coils is formed adjacent to each other on the other one of short sides of the flexible insulating substrate, and the flexible insulating substrate is configured to be folded at the bending portions such that the plurality of secondary coils is stacked one another between the pair of primary coils.

16. The planar transformer according to claim 10, wherein the plurality of input terminals and the plurality of output terminals are positioned to mount a power supply substrate to the second surface of the flexible insulating substrate.

17. The planar transformer according to claim 3, further comprising:
a plurality of input lines formed on one of the first surface and the second surface of the flexible insulating substrate such that the plurality of input lines is connected to the primary coils and that the plurality of input lines is formed along one of the pair of long sides; and
a plurality of output lines formed on the one of the first surface and the second surface of the flexible insulating substrate such that the plurality of output lines is connected to the secondary coils and that the plurality of output lines is Ruined along the other one of the pair of long sides.

18. The planar transformer according to claim 7, further comprising:
a plurality of input lines formed on one of the first surface and the second surface of the flexible insulating substrate such that the plurality of input lines is connected to the primary coils and that the plurality of input lines is fomied along one of the pair of long sides; and
a plurality of output lines fonned on the one of the first surface and the second surface of the flexible insulating substrate such that the plurality of output lines is connected to the secondary coils and that the plurality of output lines is formed along the other one of the pair of long sides.

19. The planar transformer according to claim 11, further comprising:
a plurality of input lines formed on one of the first surface and the second surface of the flexible insulating substrate such that the plurality of input lines is connected to the primary coils and that the plurality of input lines is formed along one of the pair of long sides; and
a plurality of output lines formed on the one of the first surface and the second surface of the flexible insulating substrate such that the plurality of output lines is connected to the secondary coils and that the plurality of output lines is formed along the other one of the pair of long sides.

20. The planar transformer according to claim 15, further comprising:
a plurality of input lines formed on one of the first surface and the second surface of the flexible insulating substrate such that the plurality of input lines is connected to the primary coils and that the plurality of input lines is formed along one of the pair of long sides; and
a plurality of output lines formed on the one of the first surface and the second surface of the flexible insulating substrate such that the plurality of output lines is connected to the secondary coils and that the plurality of output lines is formed along the other one of the pair of long sides.
